(19) United States
(12) Patent Application Publication
(10) Pub. No.: US 2025/0083691 A1
(43) Pub. Date: Mar. 13, 2025

(54) SPATIAL PATH GUIDANCE FOR REMOTE ASSISTANCE OF AN AUTONOMOUS VEHICLE

(71) Applicant: GM Cruise Holdings LLC, San Francisco, CA (US)

(72) Inventors: Katherine Mary Stumpf, San Francisco, CA (US); Eli Fox-Epstein, Los Angeles, CA (US)

(21) Appl. No.: 18/464,625

(22) Filed: Sep. 11, 2023

(51) Int. Cl. B60W 60/00

(52) U.S. Cl. CPC B60W 60/001; B60W 2556/45

(57) ABSTRACT

Systems and techniques are provided for providing spatial path guidance of an autonomous vehicle (AV) in a remote assistance session by leveraging input from a remote operator. An example process includes initiating a remote assistance session between a remote assistant and an AV in a scene that comprises at least a portion of a planned path of the AV, receiving a waypoint input from the remote assistant associated with the remote assistance session, and generating a spatial path for the AV to navigate based on the one or more waypoints that are provided in the waypoint input. The example process includes generating an endpoint along the spatial path and terminating the remote assistance mode in response to determining that the AV has navigated past the last control point or gracefully stopping at the endpoint to receive further assistance.

### BACKGROUND

### 1. Technical Field

The present disclosure generally relates to a remote assistance system. For example, aspects of the present disclosure relate to techniques and systems for providing spatial path guidance of an autonomous vehicle in a remote assistance session based on input from a remote operator.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at specific locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram illustrating an example system environment that can be used to facilitate autonomous vehicle (AV) navigation and routing operations, in accordance with some examples of the present disclosure;

FIG. 2 is a diagram illustrating an example system environment in which an AV is in communication with a remote assistance system, according to some examples of the present disclosure;

FIG. 3 is a flowchart illustrating an example workflow of a remote assistance mode for providing spatial path guidance of an autonomous vehicle, according to some examples of the present disclosure;

FIG. 4 is a diagram illustrating an example spatial path generated by a remote assistance system, according to some examples of the present disclosure;

FIG. 5 is a diagram illustrating an example user interface of a remote assistance system for providing spatial path guidance, according to some examples of the present disclosure;

FIG. 6 is a flowchart illustrating an example process for providing spatial path guidance in a remote assistance session by leveraging input from a remote operator, according to some examples of the present disclosure; and

FIG. 7 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspect of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

As previously described, an autonomous vehicle (AV) is a motorized vehicle that does not require a human driver. An AV is equipped with various sensors to perceive the surrounding environment and navigate. In some instances, an AV system may encounter an object or scenario (e.g., unfamiliar or challenging objects or ambiguous scenarios) that may inhibit the operation of the AV, and therefore, additional guidance is desired during the decision-making process. A remote operator (e.g., a human operator, a remote assistant, or a remote advisor) may be connected to an AV through a remote assistance system that facilitates communication between the remote operator and the AV for remote assistance or control. For example, a remote assistance system allows the remote operator to receive sensor data from the AV (e.g., live video feeds, sensor readings and measurements, diagnostic information, etc.) so that the remote operator can provide guidance, instructions, or interventions to the AV.

A remote operator is responsible for monitoring and providing support to an AV that is in need of assistance (e.g., in complex or unfamiliar situations, error event situations, etc.). If an AV encounters a situation that it cannot autonomously handle, a remote operator can assess the situation and take action to assist the AV, which may include providing instructions and/or suggestions to the AV (e.g., to lane change, to re-route, to change a mode of operation, etc.). It can be a challenging and complicated process for the remote operator to continuously provide instructions and authorize various navigating parameters for remote assistance and determine the timing of when to end the remote assistance so that the AV can resume autonomous driving.

Systems, apparatuses, processes (also referred to as methods), and computer-readable media (collectively referred to as “systems and techniques” or “system”) are described herein for providing spatial path guidance of an AV in a remote assistance session by leveraging input from a remote operator. For example, the systems and techniques can generate a spatial path for AV guidance based on one or more control points that are provided in an input from a remote operator. In some aspects, the systems and techniques can determine bounds on either or both side(s) of the spatial path that define an area that the AV can traverse. For example, the AV can be instructed or suggested to traverse within the zone that is defined by bounds on the sides of the spatial path (e.g., the sides relative to a direction of travel associated with the spatial path) instead of strictly sticking to a single line of the spatial path.

In some examples, the systems and techniques described herein can determine the timing of when to end the remote assistance mode (e.g., in particular, an assisted pathing mode) and automatically terminate the remote assistance mode independent of input/instructions from a remote operator. For example, the systems and techniques can determine an endpoint along the spatial path where remote assistance can be safely and gracefully completed. For example, when the systems and techniques determine that the AV has navigated sufficiently close to the endpoint (e.g., past the last control point along the spatial path), a remote assistance session can be automatically terminated without further input or instructions from a remote operator, and the AV can resume its autonomous driving from thereon.

In some approaches, the systems and techniques described herein can generate a spatial path that includes an avoidance area, which may be associated with AV parameters that restrict the AV from navigating the avoidance area. In some cases, an avoidance area can include regions that the AV will attempt to avoid during nominal autonomous operation. For example, the systems and techniques can generate a spatial path that may be contrary to the AV's understanding of the surrounding environment and/or parameters of the AV defining areas that the AV can and/or cannot navigate. The spatial path can deviate from or override an initial path that was planned by the AV prior to entering a remote assistance mode.

Aspects of the disclosed technology can improve the remote assistance system by eliminating the need for continuous authorization or instructions from a remote operator. For example, the systems and technologies described herein can allow an AV to follow the path that has been approved by a remote operator for a predetermined road segment. In some examples, regardless of any connectivity loss or latency that would prevent continuous authorization, an AV can safely continue traveling along the spatial path that is approved by a remote operator and gracefully and safely complete the remote assistance and resume its autonomous driving without any input or instructions from a remote operator or without having to wait for authorization or approval from a remote operator.

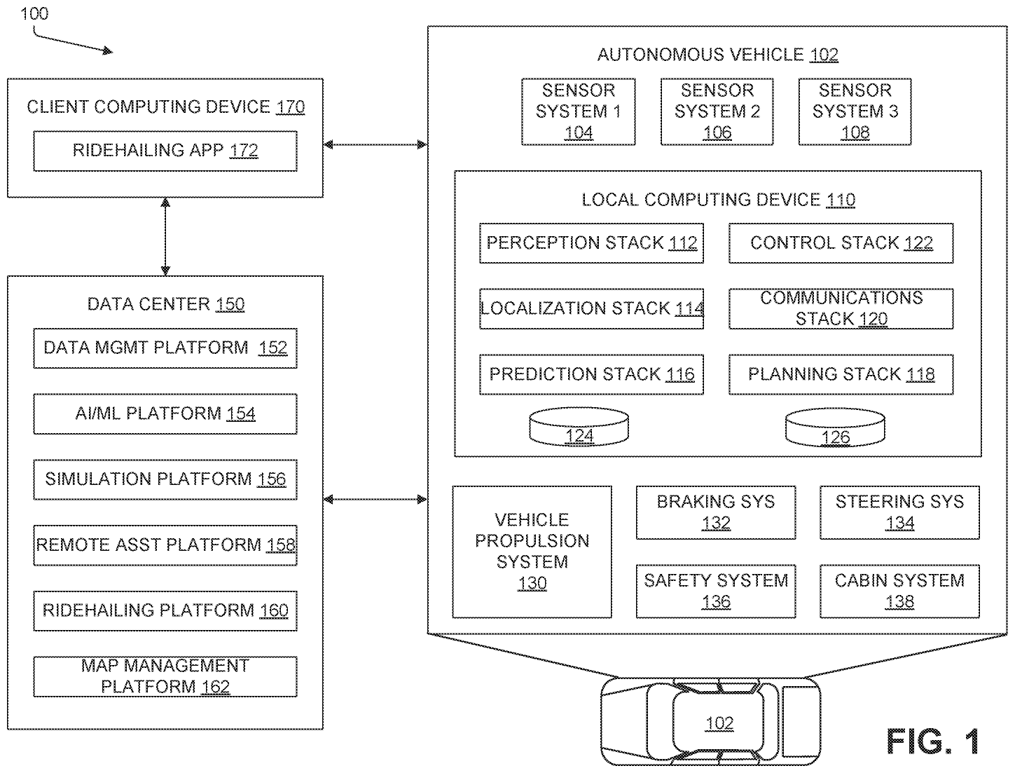

Various examples of the systems and techniques for providing spatial path guidance by leveraging input from a remote operator are illustrated in FIG. 1 through FIG. 7 and described below.

FIG. 1 is a diagram illustrating an example autonomous vehicle (AV) environment 100, according to some examples of the present disclosure. One of ordinary skill in the art will understand that, for AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the perception stack 112 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

Prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

Planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

Communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

Data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ride-hailing service (e.g., a ridesharing service), a delivery service, a remote/roadside assistance service, street services (e.g., street mapping, street patrol, street cleaning, street metering, parking reservation, etc.), and the like.

Data center 150 can send and receive various signals to and from the AV 102 and the client computing device 170. These signals can include sensor data captured by the sensor systems 104-108, roadside assistance requests, software updates, ride-hailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ride-hailing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ride-hailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for the AV 102, the remote assistance platform 158, the ride-hailing platform 160, the map management platform 162, and other platforms and systems. Simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

Ride-hailing platform 160 can interact with a customer of a ride-hailing service via a ride-hailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 172. The client computing device 170 can be a customer's mobile computing device or a computing device integrated with the AV 102 (e.g., the local computing device 110). The ride-hailing platform 160 can receive requests to pick up or drop off from the ride-hailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ride-hailing platform 160 may incorporate the map viewing services into the ride-hailing application 172 (e.g., client application) to enable passengers to view the AV 102 in transit en route to a pick-up or drop-off location, and so on.

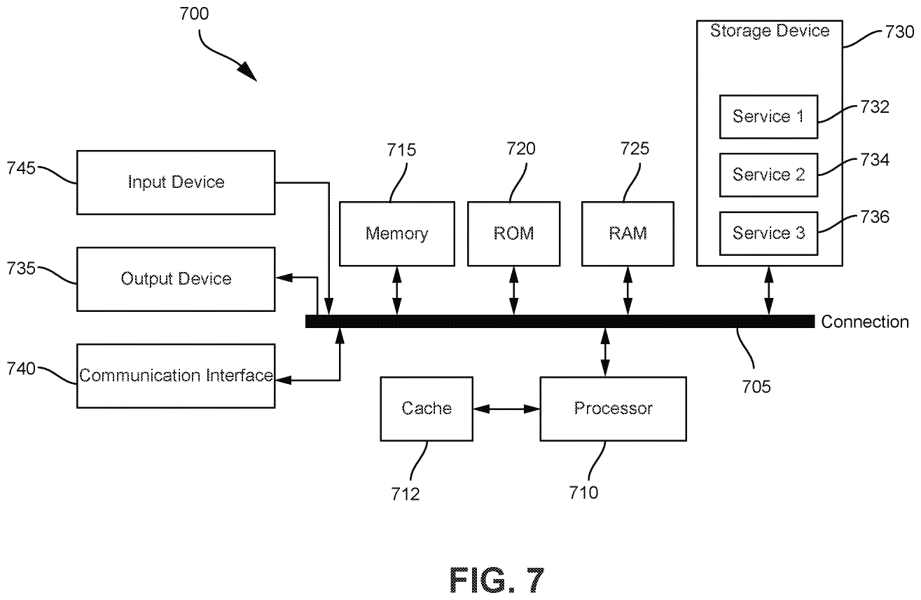

While the AV 102, the local computing device 110, and the AV environment 100 are shown to include certain systems and components, one of ordinary skill will appreciate that the AV 102, the local computing device 110, and/or the AV environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 7.

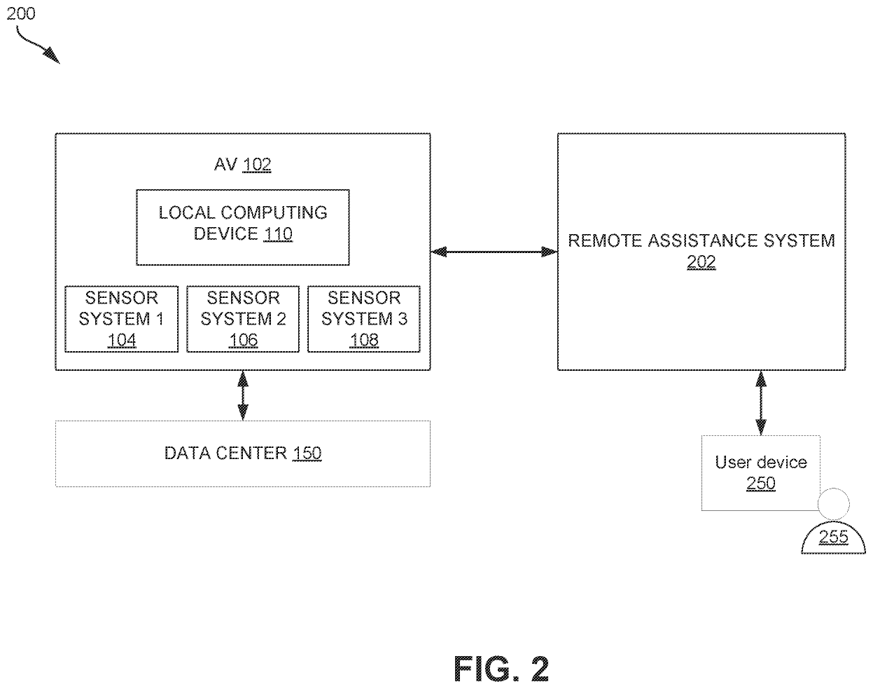

FIG. 2 illustrates an example system environment 200 in which AV 102 is in communication with a remote assistance system 202 (e.g., remote assistance platform 158 as illustrated in FIG. 1 or also referred to as a remote computing system). In some examples, remote assistance system 202 and AV 102 may establish a network connection (e.g., via Wi-Fi network, a vehicle-to-vehicle (V2V) network, a cellular network, a satellite network, or any applicable network) to facilitate data exchange and communication. While FIG. 2 depicts a single AV in communication with remote assistance system 202, other examples of remote assistance system 202 may be utilized for multiple AVs.

In the example system environment 200, remote assistance system 202 is configured to provide remote assistance to an AV (e.g., AV 102) that has encountered a scenario in which an AV needs remote assistance and/or is unable to handle the situation with sufficient confidence and/or without human assistance. For example, if AV 102 encounters an object that it cannot identify or AV 102 is unable to select appropriate maneuvers or plan a course of action due to sensor failure or environmental hazards, a remote assistance request can be generated and transmitted to remote assistance system 202. Non-limiting examples of a cause that may initiate a remote assistance request include sensor impairment (e.g., sensor failure, sensor malfunctioning, etc.); control system failure; AV operation impairment (e.g., engine problems, a flat tire, etc.); perception, prediction, and/or planning impairment (e.g., an unidentifiable object in the scene, an object blocking a view and path of the AV, etc.); vehicle rules/constraints; scene conditions; a type of scene; one or more scene features (e.g., intersection, merge lane, closed lane/road, construction zone, obstacles, etc.); AV constraints; AV parameters; error/failures experienced by the AV; events such as stuck events experienced by the AV in which the AV is unable to autonomously resolve such events; and so on.

In some aspects, remote assistance can be manually requested by an occupant of AV 102 or any other party that may be associated with AV 102. Upon receiving a request for remote assistance from AV 102, remote assistance system 202 can assign a remote operator 255 to assist AV 102. In other aspects, the AV can automatically request assistance from remote assistance system 202, or remote assistance system 202 can determine that AV 102 needs assistance in a given context/situation.

In some cases, remote assistance system 202 may access (and/or receive) data from AV 102, which can provide information associated with AV 102 and the scene of AV 102. For example, remote assistance system 202 can access a variety of data that is stored in AV operational database 124 and/or communicated by AV 102 such as raw AV data generated by sensor systems 104-108, stacks 112-122, and/or other components of AV 102 (e.g., HD LIDAR point cloud data, image data, RADAR data, GPS data); log data; other AV data; and/or data received by AV 102 from remote systems (e.g., data center 150 or client computing device 170) as illustrated in FIG. 1.

Non-limiting examples of data that may be accessible (and/or received) by remote assistance system 202 can include sensor data captured by one or more sensors of AV 102 (e.g., sensor system 1 104, sensor system 2 106, sensor system 3 108), historical data associated with AV 102 (e.g., maintenance history, vehicle or accident history, a historical behavior of AV 102, etc.), profile data associated with AV 102 (e.g., state of AV 102 such as occupancy status, make, model, dimensions, etc.), operation data associated with AV 102 (e.g., mode of operation running on AV 102, information about operation systems of AV 102, operating parameters, etc.), map data (e.g., geospatial information from map management platform 162, road geometry, lane geometry, locations and directions of traffic lanes, traffic zones (e.g., construction zone, school zone, etc.), road features (e.g., signage features, traffic lights, buildings, or other objects, etc.), traffic data, weather data, logged data from AV 102, scene data, planning data, AV predictions, AV detections, AV constraints, activity data, status data, etc.

In some examples, remote assistance system 202 can generate a remote assistance user interface (UI) that includes information relating to the data available to remote assistance system 202 about AV 102 as described above. For example, remote assistance system 202 can generate a UI to be presented at user device 250 for remote operator 255. The remote operator 255 can access information in the remote assistance UI to understand the surrounding environment of AV 102, understand the need for assistance, analyze the situation associated with a remote assistance request, determine what assistance can or should be provided to AV 102, monitor AV 102, and/or provide assistance to AV 102.

In some cases, the remote assistance UI can include one or more output elements such as a display element (e.g., a screen, a touch-sensitive screen or panel, or any suitable display, etc.). For example, the remote assistance UI can include a visual/graphical representation of the scene and AV 102 (e.g., a graphical overlay over the video or image data to display). As follows, the remote assistance UI can enable remote operator 255 to view and assess available data on user device 250.

In some aspects, the remote assistance UI can include one or more input elements (e.g., input buttons, input fields, input forms, input objects, etc.). Remote operator 255 can provide inputs to the remote assistance UI from user device 250 via one or more input mechanisms such as, for example and without limitation, a keyboard, a mouse, a tablet, a microphone, a gesture recognition system, or any suitable input device). As follows, remote operator 255 can determine or select one or more remote assistance actions or instructions for a remote assistance request and provide input via an available input element of the remote assistance UI. The input from remote operator 255 can be transmitted to AV 102 for guidance/instructions (e.g., instructions to perform the one or more remote assistance actions).

In some approaches, remote assistance system 202 may be implemented using any applicable processing system and/or device such as one or more processors or controllers similar to processor-based system 700 as described below with respect to FIG. 7.

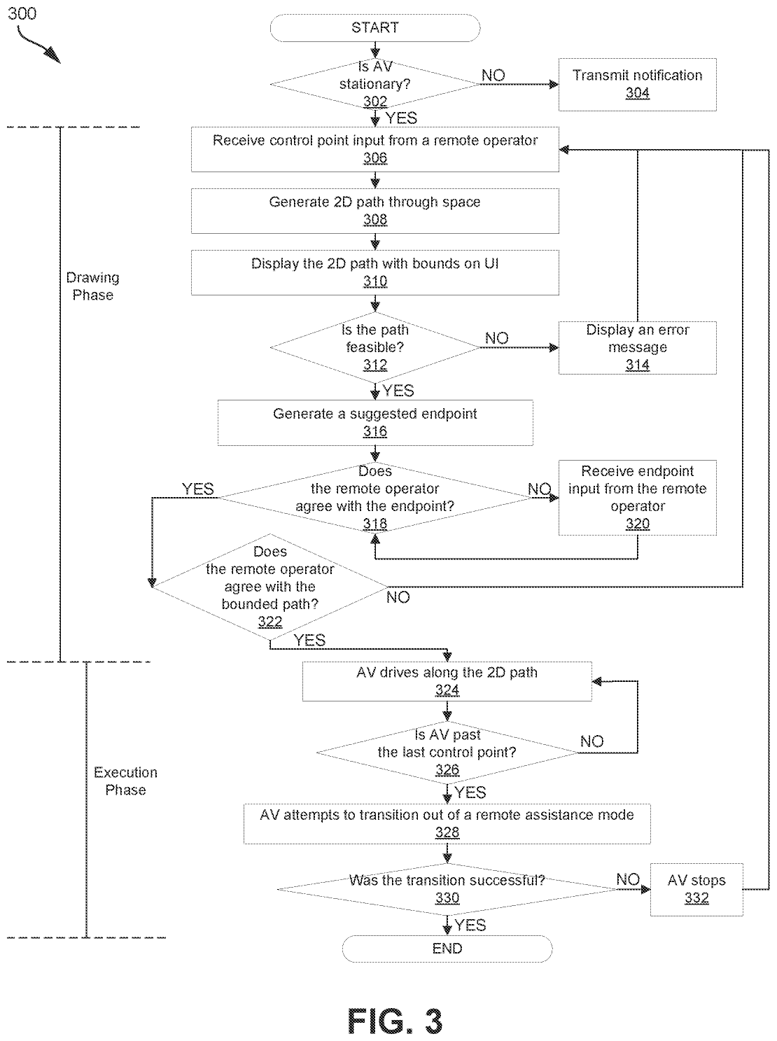

FIG. 3 is a diagram illustrating an example workflow of a remote assistance mode 300 for providing spatial path guidance of an AV. In remote assistance mode 300, a remote assistance system (e.g., remote assistance platform 158 as illustrated in FIG. 1, a remote assistance system 202 as illustrated in FIG. 2, or a remote computing system) can leverage input from a remote operator (e.g., remote operator 255) and provide spatial path guidance for an AV in a scene. Further, the remote assistance mode 300 can be automatically terminated independent of assistance from the remote operator. The remote assistance mode 300 as described herein can be referred to as one of the remote assistance modes (particularly, Assisted Pathing mode). For example, a remote assistance session may comprise various remote assistance modes, one of which includes remote assistance mode 300 as illustrated herein. While an AV is in a remote assistance session, a remote assistance system may switch between remote assistance modes (e.g., enter and end remote assistance mode 300 while in a remote assistance session).

The remote assistance mode 300 can start at step 302, which includes determining whether an AV (e.g., AV 102) is stationary in the scene. For example, a remote assistance system can determine whether an AV is stationary. If the AV is not stationary, remote assistance mode 300 can proceed to step 304, which includes transmitting a notification. For example, a remote assistance system can transmit a notification to a device associated with a remote operator to notify that the AV should be stationary for the remote assistance mode 300 to be activated.

If the AV is stationary in the scene, remote assistance mode 300 can enter a drawing phase and proceed to step 306, which includes receiving control point input from a remote operator. The remote assistance system can receive input from a remote operator that provides one or more control points that can be used as a trail of breadcrumbs for guiding the AV. In other words, the one or more control points can define a path for the AV to traverse. In some examples, the remote operator can provide a coordinate in the scene for a control point or select a location of a control point on a UI that displays a visual representation of the scene (e.g., on the remote assistance UI).

For example, in the scene where a construction zone with a series of construction cones, if an AV is having difficulty understanding the pattern of the construction cones and is unable to proceed, a remote operator can place control points in between two lines of construction cones depicted in the remote assistance UI to trigger the AV to navigate through an area in the scene represented by the two lines of construction cones depicted in the remote assistance UI.

In some cases, remote assistance mode 300 includes step 308, which includes generating a spatial path, such as a 2D spatial path. Based on the input from the remote operator regarding the control points, the remote assistance system can generate a spatial path. In some approaches, a spatial path can be generated by connecting the control points with straight line segments. In some examples, the remote assistance system can construct a curved path based on the control points to generate a smooth spatial path that can guide the AV in the scene. For example, a splining algorithm can be used to produce a smooth curve with limited curvature that attempts to go near each control point.

In some aspects, the spatial path does not necessarily pass through each and every control point that is provided by the remote operator. For example, if a control point is placed in an undrivable area (e.g., sidewalks, buildings, oncoming traffic lanes, etc.), a remote assistance system may generate a spatial path that avoids the undrivable area and use the control point as a guiding point. For example, if a control point is placed in an undrivable area, a remote assistance system or an AV may reject the control point and restore the last feasible set of control points. In some cases, the current position of an AV can be considered when building a spatial path. For example, a spatial path can be generated in a manner that it goes through the AV's position with the correct heading. In some cases, a spatial path can be generated so that the spatial path may smoothly join back up to a nominal centerline, which determines what an AV would do in nominal autonomous operation.

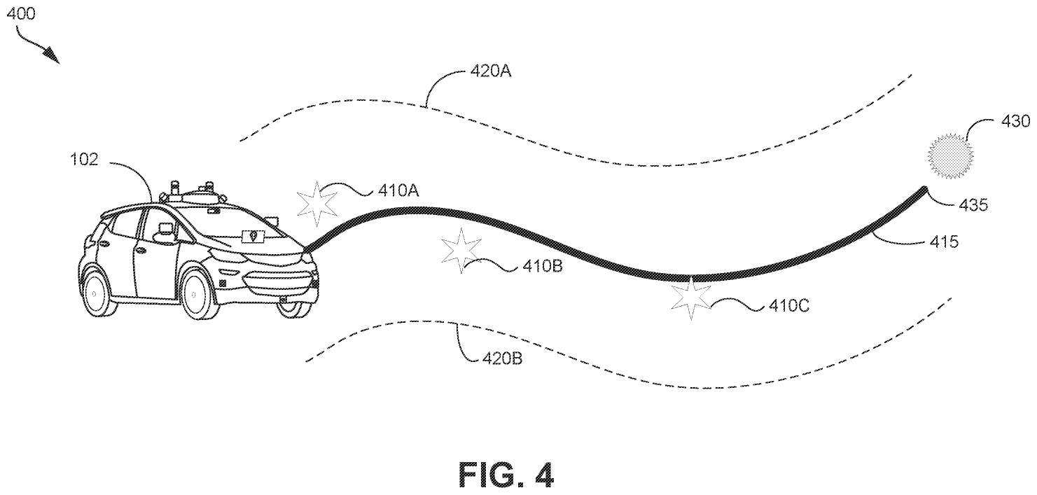

In some examples, the spatial path can include bounds on either side of the spatial path relative to a direction of travel associated with the spatial path (e.g., left and/or right of the spatial path relative to a direction of travel associated with the spatial path). The bounded areas of the spatial path can define an area that the AV can traverse during an execution phase. In some cases, the bounds can be dynamically updated as the AV travels along the spatial path based on the location, position, and motion of other static or dynamic objects around the AV. Further details of the spatial path and bounds are provided with respect to FIG. 4 below.

In some examples, at step 310, the remote assistance mode 300 includes displaying the spatial path with bounds on a UI that is associated with a remote operator (e.g., remote assistance UI associated with remote operator 255 as illustrated with respect to FIG. 2). A remote operator can review and evaluate the spatial path that is displayed on the UI.

In some cases, at step 312, remote assistance mode 300 can include determining whether the spatial path is feasible (e.g., kinematically) or receiving input from a remote operator regarding whether the spatial path is feasible (e.g., kinematically). For example, the path feasibility can be determined based on one or more constraints or factors that are associated with physical limits of an AV such as traffic rules, obstacles, AV parameters, and so on. In some examples, an AV (e.g., a motion planner, planning stack 118, control stack 122, etc.) can determine the path feasibility such as how tightly the AV can turn, how quickly the AV can accelerate, how quickly the AV can turn the steering wheel, etc.

If the spatial path is not feasible (e.g., kinematically or due to other constraints), remote assistance mode 300 proceeds to step 314, which includes displaying an error message on a UI that is associated with a remote operator and requesting the remote operator to adjust the control points or re-select the control points.

If the spatial path is kinematically feasible, remote assistance mode 300 proceeds to step 316, which includes generating a suggested endpoint. For example, the remote assistance system can display the suggested endpoint on the UI that is associated with a remote operator (e.g., remote assistance UI as illustrated with respect to FIG. 2). The location of the suggested endpoint can be determined based on one or more factors such as a distance, timing, safety of the AV, etc. In some examples, the endpoint can be selected in correspondence with the timing of how quickly the AV may get out of (or transition out of) a remote assistance mode 300 (e.g., based on current speed of the AV, an expected speed of the AV, obstacles near/around the spatial path, etc.) before getting to the endpoint.

In some examples, a region may be implicitly defined between the last control point and the endpoint. During the execution phase, the AV may start attempting to transition out of remote assistance mode 300 as soon as the AV enters the region and resume autonomous driving in the scene.

In some cases, the endpoint can be automatically placed at a fixed distance relative to the spatial path, such as a fixed distance from a location representing an end of the spatial path (e.g., a spline curve) relative to a direction of travel associated with the spatial path. For example, if the spatial path is formed from the location of the AV to point A and the AV is guided to traverse in the direction towards point A along the spatial path, a remote assistance system can automatically place the endpoint at a fixed distance from point A.

In some examples, the endpoint can be automatically placed at a fixed distance from the last control point on the spatial path (e.g., a spline curve). For example, a remote assistance system can automatically place the endpoint at a fixed distance ahead of the last control point provided by a remote operator along the spatial path.

In some approaches, a remote assistance system can select the location of the endpoint where the AV can safely and automatically end remote assistance mode 300 and resume autonomous driving. If an AV can safely transition out of remote assistance mode 300 while navigating, the AV can automatically transition out of remote assistance mode 300 in motion, for example, without any input from a remote operator. If an AV cannot transition out of remote assistance mode 300 while in motion, an AV may stop and require further remote assistance intervention. In some examples, a remote assistance system can determine a location of the endpoint based on a planned maneuver of the AV (e.g., stop, park, deaccelerating, etc.). For example, the endpoint can be placed at the nearest stop point or parking space from the end of the spatial path or the last control point of the spatial point. The remote assistance system may avoid certain areas for placing an endpoint such as an intersection, a tow zone, a construction zone, an oncoming lane, a bicycle lane, a sidewalk, an area that has a high likelihood of a collision, etc. In some cases, a remote assistance system can determine the location of the endpoint along the path approved by a remote operator. For example, an endpoint can be located along the projected path of the AV.

At step 318, remote assistance mode 300 can include receiving input from the remote operator about the suggested endpoint. For example, a remote assistance system can receive input from the remote operator regarding whether the remote operator agrees with the suggested endpoint. For example, if the endpoint is placed in an oncoming lane, the remote operator may provide input/instructions to adjust the endpoint to a location where the AV can safely stop.

If the input from the remote operator indicates that the remote operator does not agree with the suggested endpoint, remote assistance mode 300 can proceed to step 320, which includes receiving input from the remote operator regarding the endpoint. For example, the remote operator can select a new location for the endpoint or provide a new coordinate in the scene for the endpoint.

If the input from the remote operator indicates that the remote operator agrees with the suggested endpoint, remote assistance mode 300 can proceed to step 322, which includes receiving input from the remote operator regarding the bounded path. For example, the remote operator is asked to review and evaluate the spatial path with bounds.

If the input from the remote operator indicates that the remote operator does not agree with the bounded path, remote assistance mode 300 can proceed to step 306, which includes receiving control point input from the remote operator. For example, if the remote operator does not agree with the bounded path, a remote assistance system may request the remote operator to adjust the control points that are previously provided or provide new control point(s) so that the spatial path can be adjusted and/or newly generated.

Although the drawing phase in FIG. 3 (including steps 306 through 322) depict a particular sequence of operations, the sequence may be altered without departing from the scope of the disclosed technology. For example, steps 306 through 322 can be performed in any order or sequence within the drawing phase as a remote operator or a remote assistance system continuously evaluates the path bounds and the endpoint placement (e.g., a maneuver endpoint placement) within the drawing phase. In some cases, the approval of both of the path bounds and the endpoint may occur simultaneously upon moving to and entering the executing phase.

In some approaches, at step 324, remote assistance mode 300 enters an execution phase where AV drives along the spatial path. The AV's actual path may vary so long as it remains within the bounds as defined in step 308.

In some cases, remote assistance mode 300 can include step 326, which includes determining whether the AV has traversed the last control point on the spatial path (e.g., whether the AV has traversed a location associated with the last control point on the spatial path). For example, as the AV traverses along the spatial path in the scene, the remote assistance system can determine whether the AV has passed the last control point along the spatial path.

If the AV has passed the last control point, at step 328, the AV can attempt to transition out of remote assistance mode 300. For example, if the remote assistance system determines that the AV is past the last control point along the spatial path, the remote assistance system can complete remote assistance mode 300 and have the AV resume autonomous driving without assistance from a remote operator.

In some cases, during the execution phase and traversing along the spatial path, if it is necessary to avoid a collision, an AV may violate the boundaries as defined in step 308 and/or the endpoint (e.g., a maneuver endpoint) that the AV would have abided otherwise.

In some examples, remote assistance mode 300 can include step 330, which includes determining whether the transitioning out of remote assistance mode 300 was successful. If the AV was not able to gracefully transition out of remote assistance mode 300, remote assistance mode 300 can proceed to step 332 where the AV stops at the maneuver end point, and further to step 306 where the remote assistance system receives input from the remote operator for adjusted or new control points for path guidance.

If the automatic transitioning out of the remote assistance session was successful without any input from a remote operator, the remote assistance mode 300 ends and the AV resumes driving nominally (e.g., driving autonomously) without any further assistance or input from a remote assistance system or a remote operator.

FIG. 4 is a diagram illustrating a graphical representation 400 of generating a spatial path for an AV by leveraging input from a remote operator. As previously described, a remote assistance system can generate a spatial path 415 with bounds 420A, 420B for guiding an AV 102 based on input from a remote operator that provides one or more control points 410A, 410B, 410C (collectively, control point(s) 410).

In some examples, a remote assistance system (e.g., remote assistance platform 158 as illustrated in FIG. 1, a remote assistance system 202 as illustrated in FIG. 2, or a remote computing system) may receive input from a remote operator (e.g., remote operator 255) relating to one or more control points. For example, a remote operator can provide a coordinate for control point 410 or select the location of control point 410 on a UI associated with the remote operator. The control point(s) 410 can provide arbitrary waypoints for a path that the remote operator would like the AV to travel in the scene to resolve the difficulty or issue that the AV has encountered in the scene.

The number of control points 410 in the scene can vary (e.g., from one point to as many points as the remote operator desires) depending on the complexity of the scene. For example, if the scene comprises a complicated road geometry or lane geometry, a high number of control point 410 would be needed to form spatial path 415 for AV 102 to safely drive through the complicated scene. If AV 102 is in a rural area that has a simple road geometry or lane geometry or does not have dynamic objects that are moving at a high speed, only a few control points 410 would be sufficient to generate a spatial path 415 to guide AV 102.

In some aspects, spatial path 415 does not necessarily pass through each control point 410. A remote assistance system, when generating spatial path 415 based on control points 410, can consider control point 410 as an arbitrary guiding point to avoid any undrivable area in the scene. For example, if control point 410 is placed in an undrivable area such as sidewalks, buildings, oncoming traffic lanes, etc., or if one of control point 410 cannot be connected to another control point, a remote assistance system can generate spatial path 415 that does not pass through each control point 410 but an area that AV 102 can safely traverse.

In some cases, the bounds 420A, 420B can determine the area that AV 102 can travel within. For example, the AV is guided to traverse within the area that is bounded by bounds 420A, 420B. The width between the bounds 420A and 420B can be determined, in a static or a dynamic manner, based on various factors such as the size of AV 102, proximity to other objects near AV 102, road geometry, lane geometry, and so on.

For example, if spatial path 415 is drawn in between two lines of construction cones (e.g., AV 102 needs to drive through in between two lines of construction cones), the bounds 420A and 420B can be determined based on the width w of AV 102 and the lateral distance d between two lines of construction cones. For example, the distance D between bounds 420A and 420B can be calculated by dividing the sum of d and w by 2 (e.g., D=(d+w)/2).

In some cases, a remote assistance system or a remote operator may provide suggestions or additional input to adjust the bounds (e.g., bounds 420A, 420B). For example, an input can be provided to make the bounds 420A and 420B wider on the left side of the AV's spatial path 415 and narrower on the right side of the spatial path 415.

In some examples, the area that is bounded by bounds 420A, 420B overlap an area that is not permitted to drive (e.g., a sidewalk, a location of a pedestrian, a construction zone, etc.), the bounds 420A, 420B may be adjusted to create cutouts or non-linear shapes to account for the areas or objects that need to be avoided.

As previously described, while AV 102 is suggested to drive along spatial path 415 and stay within bounds 420A, 420, in some cases, AV 102 may violate the path boundaries (e.g., driving outside of bounds 420A or 402B) in order to avoid a collision or a safety critical event (e.g., near miss, etc.).

In some aspects, a remote assistance system can generate an endpoint 430, which determines the location and timing of when the remote assistance from a remote operator is to be phased out. As previously described, the location of endpoint 430 can be determined based on one or more factors such as a distance, timing, safety of the AV, etc.

In some examples, endpoint 430 can be automatically placed at a fixed distance from the end 435 of spatial path 415 relative to a direction of travel or at a fixed distance from the last control point 510C along the spatial path 415.

In some approaches, a remote assistance system can adjust the location of endpoint 530 so that the AV can safely stop and await further assistance if the AV cannot successfully transition out of remote assistance and resume autonomous driving. For example, a remote assistance system may avoid an area such as a two zone, a construction zone, the middle of an intersection, the middle of a crosswalk, an oncoming lane, a bicycle lane, a sidewalk, or any area that has a high likelihood of a collision. For example, a remote assistance system would try to place endpoint 530 at the nearest stop point or parking space.

As previously illustrated, if an AV cannot safely transition out of remote assistance mode 300 while in motion, in order to avoid sudden stops or hard braking, the AV will gradually slow down as the AV approaches the endpoint (e.g., a maneuver endpoint) and stop at the endpoint. In some aspects, this stopping solution may be canceled if the AV is successfully able to transition out of remote assistance mode 300 after passing the last control point.

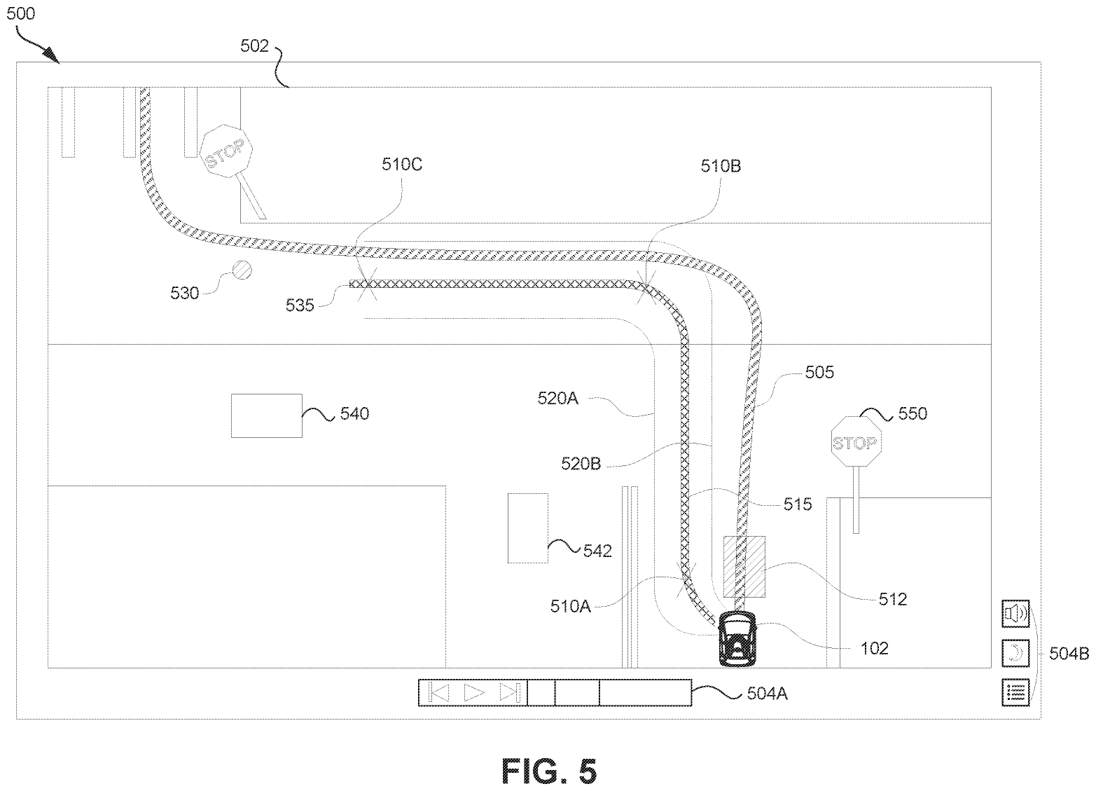

FIG. 5 is a diagram illustrating an example user interface (UI) 500 of a remote assistance system for providing spatial path guidance. In some examples, the UI 500 generated and/or provided by a remote assistance system may be displayed via a device associated with a remote operator (e.g., user device 250 associated with remote operator 255 as illustrated in FIG. 2). A remote operator can interact with UI 500 to analyze data presented in the UI 500, communicate with AV 102, provide inputs, and so on.

In some aspects, UI 500 can include one or more output elements as a display element (e.g., a screen, a touch-sensitive screen or panel, or any suitable display, etc.) and input elements (e.g., a keyboard, a mouse, a tablet, a microphone, or any suitable input device) that facilitate the interaction between a remote operator, a remote assistance system, and an AV.

In some examples, UI 500 can include a graphical/visual representation of the scene, which may be displayed in map display window 502. The map display window 502 can include a visual representation of the position and location of AV 102 in the scene and visual representations of road features, scene features (e.g., static and/or dynamic objects in the scene) overlaid on a map. In some aspects, map display window 502 can include a planned path 505 of AV 102 and predicted trajectories (not shown) of object(s) 512, 540, 542 in the scene overlaid on the map.

In some cases, UI 500 can include interface elements 504A, 504B that allow a remote operator to provide inputs for interacting with the UI 500 and AV 102. The interface elements 504A, 504B can include, for example and without limitation, a playback bar, slider or a seek bar, time scale, a mute button, a volume control, a play speed, a control menu, a mode, zoom in/out, edit tools, AV control and/or interaction tools, and so on. Those skilled in the art will understand that map display window 502 and interface elements 504A, 504B can be in any applicable number of boxes/buttons without departing the scope of the disclosed technology.

As shown, the scene displayed in map display window 502 includes AV 102, which is stuck behind vehicle 512 and cannot proceed along the planned path 505. To assist the stuck AV 102, a remote assistance system may begin a remote assistance mode (e.g., remote assistance mode 300) that provides spatial path guidance. In some examples, the remote assistance session can be initiated in response to a remote assistance request or an input/selection from a remote operator. For example, a remote assistance session can be initiated between a device (e.g., a computer, a computing device, etc.) of a remote operator and AV 102.

In some aspects, upon reviewing and/or evaluating the scene (e.g., road features, scene features, static or dynamic objects in the scene), a remote operator may provide input/instructions to assist the stuck AV 102. For example, the remote operator may determine, after reviewing the scene, that AV 102 can move ahead of vehicle 512 that is in front of AV 102 and proceed forward. In order to provide an instruction in accordance with such determination, the remote operator can designate control points 510A-510C (or provide coordinates for control points 510A-510C) in the scene. In some examples, control points 510A-510C in the scene can be displayed in map display window 502 based on input from a remote operator.

A remote assistance system can generate the spatial path 515 based on the control points 510A-510C. The spatial path 515 describes a specific path for AV 102 to travel from a current location to the last control point 510C designated by the remote operator. In some aspects, the spatial path 515 can be constructed as a function of spline defined by control points 510A-510C so that the spatial path 515 can be a smooth path that can guide AV 102 in the scene.

In some examples, a remote assistance system can generate bounds on either side (left and/or right) that define an area that AV 102 can traverse. The area defined by the bounds 520A, 520B can be determined based on various factors such as the size of AV 102, proximity to other objects near AV 102, road geometry, lane geometry, or a combination thereof.

In some cases, once the spatial path is generated, a remote assistance system can generate an endpoint 530. As illustrated previously with respect to FIG. 3 and FIG. 4, endpoint 530 can be automatically generated based on one or more factors such as a distance, timing, safety of the AV, etc. For example, endpoint 530 can be at a predetermined distance from the end 535 of spatial path 515 or the last control point 510C along spatial path 515.

In some aspects, one or more navigation parameters along spatial path 515 can be controlled and/or adjusted based on input from a remote operator. For example, upon reviewing and evaluating the scene (e.g., the validity of the scene features and/or road features), a remote operator may provide input that adjusts one or more navigation parameters along spatial path 515, which determine the behavior or operation of AV 102. Examples of navigating parameters that can be adjusted based on the remote operator's input can include a type of maneuver (e.g., stop, assert, or yield), steering parameter, braking parameter, signals, maximum speed, minimum speed, etc.

In some examples, a remote operator may identify a map change, invalid stop point, invalid school bus zone, etc. and provide input that may adjust the operating and/or navigating behavior of AV 102. For example, a remote operator may determine that the stop point 550 is no longer valid and provide input to adjust the AV's behavior not to stop at stop point 550. As follows, a remote assistance system may receive maneuver input from a remote operator, which eliminates a stop point 550 along spatial path 515 of AV 102 so that AV 102 is instructed not to stop at the stop point 550 when traversing along spatial path 515 during the execution phase (e.g., at step 324 of remote assistance mode 300 as illustrated in FIG. 3). In some examples, a stop point 550 may be lifted at certain stop point types, only in the drawing phase as illustrated in FIG. 3, while AV 102 is stationary and is within a certain distance from stop point 550, and/or a combination thereof. As follows, AV 102 may be prevented from driving through stop point 550 at speed if the identification of an invalid stop point was mistakenly made.

In some examples, spatial path 515 can pass through an avoidance area, which may be associated with AV parameters that restrict AV 102 from navigating the avoidance area or may be particularly challenging for AV 102 (e.g., a complex construction zone, an active emergency scene, etc.). As follows, spatial path 515 that guides AV 102 can include a road segment, a maneuver, or an area that may be contrary to the AV's understanding of the surrounding environment based on a remote operator's evaluation of the invalidity of the avoidance area. For example, a planned path 505 of AV 102 may not allow AV 102 to cut in another vehicle 512 at stop point 550. If a remote operator reviews and evaluates the scene and determines that vehicle 512 has broken down and would stay stationary for a while, a remote operator can provide input for cutting in vehicle 512 and proceeding forward. Based on such input from the remote operator, spatial path 515 can guide AV 102 to cut in vehicle 512 overriding the AV's initial understanding of the scene.

In some examples, an avoidance area (e.g., a construction zone, an active emergency scene) may be placed and removed with a delay based on operations, a remote operator who/that is currently assisting AV 102 may be able to confirm that the avoidance area is valid or invalid (e.g., whether the emergency scene is no longer active, or whether the construction has been resolved, etc.) and instruct and/or suggest AV 102 to drive through that avoidance area.

In some aspects, some rules that are present in nominal driving (e.g., autonomous operations) but may be violated in generating a spatial path can include AV 102 not respecting lane boundaries, certain features being turned off (e.g., construction cone grouping to create a construction channelization) because a remote assistance system or a remote operator is expected to solve erroneous detections or decisions by such features. For example, spatial path 515 can be generated in a manner that allows lane splitting or driving in an oncoming lane for long distance, for example, to correctly follow a construction channelization.

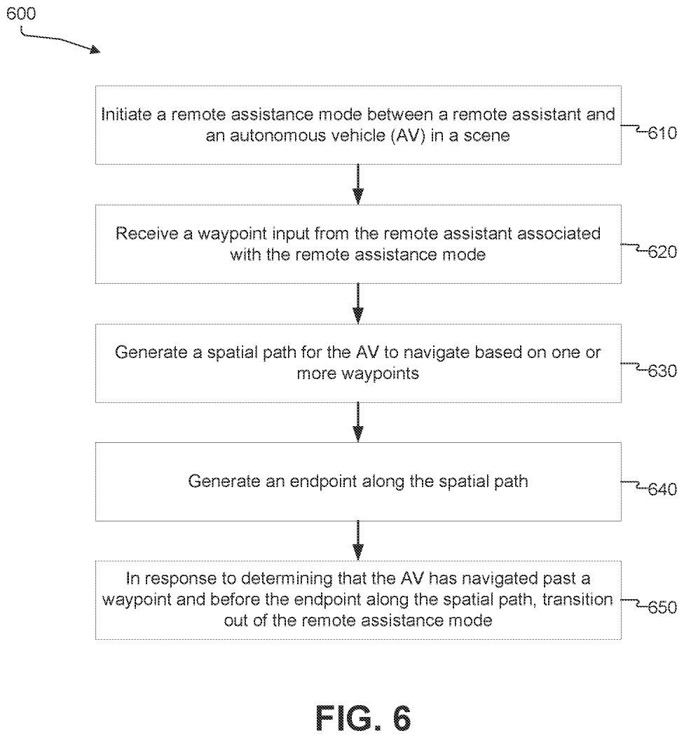

FIG. 6 is a flowchart illustrating an example process 600 for providing spatial path guidance of an AV in a remote assistance session by leveraging input from a remote operator and automatically terminating the remote assistance mode independent of assistance from the remote operator. Although the example process 600 depicts a particular sequence of operations, the sequence may be altered without departing from the scope of the present disclosure. For example, some of the operations depicted may be performed in parallel or in a different sequence that does not materially affect the function of process 600. In other examples, different components of an example device or system that implements process 600 may perform functions at substantially the same time or in a specific sequence.

At block 610, process 600 includes initiating a remote assistance mode between a remote assistant and an AV in a scene. For example, remote assistance system 202 can start a remote assistance mode (e.g., remote assistance mode 300) between remote operator 255 and AV 102 in a scene. The scene may include at least a portion of a planned path of AV 102 (e.g., planned path 505 as illustrated in FIG. 5). In some examples, the remote assistance mode 300 can be initiated by AV 102 that is no longer able to proceed along the planned path 505 and needs remote assistance.

At block 620, process 600 includes receiving a waypoint input from the remote assistant associated with the remote assistance mode. For example, remote assistance system 202 can receive input from remote operator 255 associated with the remote assistance mode (e.g., remote assistance mode 300) regarding control points in the scene (e.g., control points 410A-410C, control points 510A-510C). Based on the control point input from remote operator 255, remote assistance UI (e.g., UI 500) that is associated with remote operator 255 can display the visual representations of the location(s) of the control points.

At block 630, process 600 includes generating a spatial path for the AV to navigate based on the one or more waypoints. In some examples, the spatial path can deviate from at least the portion of the planned path of the AV. For example, remote assistance system 202 can generate spatial path 415 (or spatial path 515) for AV 102 to navigate based on one or more waypoints (e.g., control points 410A-410C, control points 510A-510C). As previously described, spatial path 515 may deviate from at least a portion of planned path 505 in order to assist AV 102 or resolve the remote assistance request.

At block 640, process 600 includes generating an endpoint along the spatial path. For example, remote assistance system 202 can generate endpoint 430 (or endpoint 530) along the spatial path 415 (or spatial path 515). In some examples, the endpoint is located at a predetermined distance from the last control point (e.g., control point 410C or 510C) along the spatial path 415 (or spatial path 515).

At block 650, process 600 includes terminating the remote assistance session in response to determining that the AV has navigated past the last control point. For example, remote assistance system 202 can terminate remote assistance mode 300 in response to a determination that AV 102 has navigated past the last control point 430 (or endpoint 530). As follows, AV 102 can resume autonomous driving without further remote assistance.

FIG. 7 illustrates an example processor-based system with which some aspects of the subject technology can be implemented. For example, processor-based system 700 can be any computing device making up local computing device 110, client computing device 170, a passenger device executing the ride-hailing application 172, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some examples, computing system 700 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communication interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 730 can include software services, servers, services, etc., that when the code that defines such software is executed by the processor 710, it causes the system 700 to perform a function. In some examples, a hardware service that performs a particular function can include the software component stored in a computer-readable medium in connection with the necessary hardware components, such as processor 710, connection 705, output device 735, etc., to carry out the function.

Examples within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the examples and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A remote assistance system comprising: a memory; and one or more processors coupled to the memory, the one or more processors being configured to: initiate a remote assistance mode between a remote assistant and an autonomous vehicle (AV) in a scene, the scene comprising at least a portion of a planned path of the AV; receive a waypoint input from the remote assistant associated with the remote assistance mode, wherein the waypoint input includes one or more waypoints in the scene; generate a spatial path for the AV to navigate based on the one or more waypoints, the spatial path modifying at least the portion of the planned path of the AV; generate an endpoint along the spatial path; and in response to determining that the AV has navigated past a waypoint and before the endpoint along the spatial path, transition out of the remote assistance mode, wherein the waypoint represents an end of the spatial path relative to a direction of travel associated with the spatial path.

Aspect 2. The remote assistance system of Aspect 1, wherein the one or more processors are configured to: display the spatial path along with the planned path of the AV on an interface associated with the remote assistant of the AV.

Aspect 3. The remote assistance system of Aspects 1 or 2, wherein the spatial path defines bounds that the AV can traverse.

Aspect 4. The remote assistance system of any of Aspects 1 to 3, wherein the endpoint is located at a predetermined distance from a waypoint of the one or more waypoints.

Aspect 5. The remote assistance system of any of Aspects 1 to 4, wherein the one or more processors are configured to: in response to determining that transitioning out of the remote assistance mode is unsuccessful, transmit an instruction to the AV to stop at the endpoint.

Aspect 6. The remote assistance system of any of Aspects 1 to 5, wherein the one or more processors are configured to: determine a location of the endpoint based on a planned maneuver of the AV.

Aspect 7. The remote assistance system of any of Aspects 1 to 6, wherein the one or more processors are configured to: receive an endpoint input from the remote assistant; and adjust the endpoint based on the endpoint input from the remote assistant.

Aspect 8. The remote assistance system of any of Aspects 1 to 7, wherein the spatial path includes an avoidance area associated with one or more AV parameters that restrict the AV from navigating the avoidance area, and wherein the planned path excludes the avoidance area.

Aspect 9. The remote assistance system of any of Aspects 1 to 8, wherein the one or more processors are configured to: receive a maneuver input from the remote assistant; and adjust one or more navigation parameters associated with the spatial path based on the maneuver input.

Aspect 10. The remote assistance system of Aspect 9, wherein adjusting the one or more navigation parameters includes eliminating one or more stop points along the spatial path of the AV.

Aspect 11. A method comprising: initiating a remote assistance mode between a remote assistant and an autonomous vehicle (AV) in a scene, the scene comprising at least a portion of a planned path of the AV; receiving a waypoint input from the remote assistant associated with the remote assistance mode, wherein the waypoint input includes one or more waypoints in the scene; generating a spatial path for the AV to navigate based on the one or more waypoints, the spatial path modifying at least the portion of the planned path of the AV; generating an endpoint along the spatial path; and in response to determining that the AV has navigated past a waypoint and before the endpoint along the spatial path, transitioning out of the remote assistance mode, wherein the waypoint represents an end of the spatial path relative to a direction of travel associated with the spatial path.

Aspect 12. The method of Aspect 11, further comprising: display the spatial path along with the planned path of the AV on an interface associated with the remote assistant of the AV.

Aspect 13. The method of Aspects 11 or 12, wherein the spatial path defines bounds that the AV can traverse.

Aspect 14. The method of any of Aspects 11 to 13, wherein the endpoint is located at a predetermined distance from a waypoint of the one or more waypoints.

Aspect 15. The method of any of Aspects 11 to 14, further comprising: in response to determining that transitioning out of the remote assistance mode is unsuccessful, transmitting an instruction to the AV to stop at the endpoint.

Aspect 16. The method of any of Aspects 11 to 15, further comprising: determine a location of the endpoint based on a planned maneuver of the AV.

Aspect 17. The method of any of Aspects 11 to 16, further comprising: receive an endpoint input from the remote assistant; and adjust the endpoint based on the endpoint input from the remote assistant.

Aspect 18. The method of any of Aspects 11 to 17, wherein the spatial path includes an avoidance area associated with one or more AV parameters that restrict the AV from navigating the avoidance area, and wherein the planned path excludes the avoidance area.

Aspect 19. The method of any of Aspects 11 to 18, further comprising: receiving a maneuver input from the remote assistant; and adjusting one or more navigation parameters associated with the spatial path based on the maneuver input.

Aspect 20. A non-transitory computer-readable medium comprising instructions which, when executed by one or more processors, cause the one or more processors to perform a method according to any of Aspects 11 to 19.

Aspect 21. A system comprising means for performing according to any of Aspects 11 to 19.

Aspect 22. The system of Aspect 21, wherein the system comprises an autonomous vehicle.

Aspect 23. A computer-program product including instructions which, when executed by one or more processors, cause the one or more processors to perform a method according to any of Aspects 11 to 19.

What is claimed is:

1. A remote assistance system comprising:
a memory; and
one or more processors coupled to the memory, the one or more processors being configured to:
initiate a remote assistance mode between a remote assistant and an autonomous vehicle (AV) in a scene, the scene comprising at least a portion of a planned path of the AV;
receive a waypoint input from the remote assistant associated with the remote assistance mode, wherein the waypoint input includes one or more waypoints in the scene;
generate a spatial path for the AV to navigate based on the one or more waypoints, the spatial path modifying at least the portion of the planned path of the AV;
generate an endpoint along the spatial path; and
in response to determining that the AV has navigated past a waypoint and before the endpoint along the spatial path, transition out of the remote assistance mode, wherein the waypoint represents an end of the spatial path relative to a direction of travel associated with the spatial path.

2. The remote assistance system of claim 1, wherein the one or more processors are configured to:
display the spatial path along with the planned path of the AV on an interface associated with the remote assistant of the AV.

3. The remote assistance system of claim 1, wherein the spatial path defines bounds that the AV is permitted to traverse.

4. The remote assistance system of claim 1, wherein the endpoint is located at a predetermined distance from a waypoint of the one or more waypoints.

5. The remote assistance system of claim 1, wherein the one or more processors are configured to:
in response to determining that transitioning out of the remote assistance mode is unsuccessful, transmit an instruction to the AV to stop at the endpoint.

6. The remote assistance system of claim 1, wherein the one or more processors are configured to:
determine a location of the endpoint based on a planned maneuver of the AV.

7. The remote assistance system of claim 1, wherein the one or more processors are configured to:
receive an endpoint input from the remote assistant; and
adjust the endpoint based on the endpoint input from the remote assistant.

8. The remote assistance system of claim 1, wherein the spatial path includes an avoidance area associated with one or more AV parameters that restrict the AV from navigating the avoidance area, and wherein the planned path excludes the avoidance area.

9. The remote assistance system of claim 1, wherein the one or more processors are configured to:
receive a maneuver input from the remote assistant; and
adjust one or more navigation parameters associated with the spatial path based on the maneuver input.

10. The remote assistance system of claim 9, wherein adjusting the one or more navigation parameters includes eliminating one or more stop points along the spatial path of the AV.

11. A method comprising:
initiating a remote assistance mode between a remote assistant and an autonomous vehicle (AV) in a scene, the scene comprising at least a portion of a planned path of the AV;
receiving a waypoint input from the remote assistant associated with the remote assistance mode, wherein the waypoint input includes one or more waypoints in the scene;
generating a spatial path for the AV to navigate based on the one or more waypoints, the spatial path modifying at least the portion of the planned path of the AV;
generating an endpoint along the spatial path; and
in response to determining that the AV has navigated past a waypoint and before the endpoint along the spatial path, transitioning out of the remote assistance mode, wherein the waypoint represents an end of the spatial path relative to a direction of travel associated with the spatial path.

12. The method of claim 11, further comprising:
display the spatial path along with the planned path of the AV on an interface associated with the remote assistant of the AV.

13. The method of claim 11, wherein the spatial path defines bounds that the AV can traverse.

14. The method of claim 11, wherein the endpoint is located at a predetermined distance from a waypoint of the one or more waypoints.

15. The method of claim 11, further comprising:
in response to determining that transitioning out of the remote assistance mode is unsuccessful, transmitting an instruction to the AV to stop at the endpoint.

16. The method of claim 11, further comprising:
determine a location of the endpoint based on a planned maneuver of the AV.

17. The method of claim 11, further comprising:
receive an endpoint input from the remote assistant; and
adjust the endpoint based on the endpoint input from the remote assistant.

18. The method of claim 11, wherein the spatial path includes an avoidance area associated with one or more AV parameters that restrict the AV from navigating the avoidance area, and wherein the planned path excludes the avoidance area.

19. The method of claim 11, further comprising:
receiving a maneuver input from the remote assistant; and
adjusting one or more navigation parameters associated with the spatial path based on the maneuver input.

20. A non-transitory computer-readable medium comprising instructions which, when executed by one or more processors, cause the one or more processors to:
initiate a remote assistance mode between a remote assistant and an autonomous vehicle (AV) in a scene, the scene comprising at least a portion of a planned path of the AV;
receive a waypoint input from the remote assistant associated with the remote assistance mode, wherein the waypoint input includes one or more waypoints in the scene;
generate a spatial path for the AV to navigate based on the one or more waypoints, the spatial path modifying at least the portion of the planned path of the AV;
generate an endpoint along the spatial path; and
in response to determining that the AV has navigated past a waypoint and before the endpoint along the spatial path, transition out of the remote assistance mode, wherein the waypoint represents an end of the spatial path relative to a direction of travel associated with the spatial path.
